(19) United States
(12) Patent Application Publication
(10) Pub. No.: US 2026/0122126 A1
(43) Pub. Date: Apr. 30, 2026

(54) CONTAINER REGISTRY ARTIFACT RETRIEVAL USING PEER-TO-PEER PROXYING

(71) Applicant: Microsoft Technology Licensing, LLC, Redmond, WA (US)

(72) Inventors: Aviral TAKKAR, Bellevue, WA (US); Sajay ANTONY, Woodinville, WA (US); Bin DU, Redmond, WA (US); Clark AIdin PORTER, DuPont, WA (US)

(21) Appl. No.: 18/934,179

(22) Filed: Oct. 31, 2024

(51) Int. Cl. H04L 67/1061; H04L 41/16; H04L 67/06

(52) U.S. Cl. CPC H04L 67/1065; H04L 41/16; H04L 67/06

(57) ABSTRACT

Requests for artifact data for a containerized application cluster are proxied from a first region of a cloud service to a second region of the cloud service, or another cloud service. A request for the artifact data is received at a first container registry at the first region. The first container registry determines that the artifact data is locally unavailable and in response thereto identifies a peer container registry at the second region that has a copy of the artifact data. A request is sent to the peer container registry for the copy of the artifact data. If the request originated from a local client, then the artifact data is forwarded to the local client via an application programming interface, in some examples.

### BACKGROUND

Deployment of containerized applications using an orchestration platform such as Kubernetes requires availability of artifacts that contain data, including container images and other data that must be deployed to instantiate containers or to verify provenance, authenticity, and integrity of container images when launching the containerized applications or when otherwise needed by containerized applications. These artifacts are typically compliant with standards promulgated by the Open Container Initiative (OCI), and are therefore commonly referred to as “OCI Artifacts” or “OCI images.” Cloud platforms provide a container registry, which provides a hypertext transport protocol (HTTP) service to access OCI artifacts, e.g., by Kubernetes clusters.

For example, when a new container is launched, a Kubelet running on the server node where the container will be running initiates a process to pull the OCI image for the container from the container registry service. The Kubelet is a management agent for the Kubernetes cluster that runs on each node. The Kubelet communicates with a container runtime on the node (e.g., containerd or Docker) to pull the image. The container runtime then makes an application programming interface (API) call to the container registry to fetch the artifact containing the image and metadata. Typically, the request is made to an API of the container registry service using a representational state transfer (REST) application programming interface (API), following the OCI distribution specification.

Cloud users can create Kubernetes clusters for hosting their containerized applications in a plurality of geographical regions for reduced latency when serving content to geographically diverse consumers of that content, for high availability, for failover, and for other reasons. To provide availability of artifacts across the multiple geographic regions, major cloud providers provide a geo-replication service for replicating artifacts to each geographical region in which the users wish to deploy their application.

### SUMMARY

Examples of implementation approaches of a system, method, and a computer storage medium for proxying requests for artifact data from a first region of a public cloud service to a second region of the public cloud service are described herein. The system comprises a processor for executing instructions, a computer storage medium for storing the instructions, the instructions causing the processor to perform the proxying. The proxying comprises identifying a request for the artifact data at a first container registry in the first region, determine that the artifact data is locally unavailable, and, in response to the determining that the artifact data is locally unavailable, identify a peer container registry in the second region that has a copy of the artifact data and send a request to the peer container registry for the copy of the artifact data. In an illustrative implementation, the system identifies and selects the best peer container registry based on selected criteria, such as performance and/or based on compliance needs such as the European Union's General Data Protection Regulation (GDPR). The proxying further comprises receiving the requested artifact data and forwarding the requested artifact data to the client.

### BRIEF DESCRIPTION OF THE DRAWINGS

The disclosed examples are described in detail below with reference to the accompanying drawing figures listed below:

FIG. 1 is a block drawing that illustrates by way of example a multi-region cloud system.

FIG. 2 shows a time-space diagram illustrating by way of example a communication pattern for locating the requested artifact using a distributed hash table.

FIG. 3 shows a flowchart illustrating by way of example a process for proxying a request for artifact data.

FIG. 4 shows a flowchart illustrating by way of example a process for proxying requests for artifact data.

FIG. 5 shows a flowchart illustrating by way of example a process for a container registry to follow when receiving a request for artifact data from peer container registry.

FIG. 6 shows a flowchart illustrating by way of example a process for enabling proxying to a new region.

FIG. 7 is a block diagram of an example computing device.

Corresponding reference characters indicate corresponding parts throughout the drawings. Any of the figures may be combined into a single example or embodiment.

### DETAILED DESCRIPTION

For clients having multiple deployments of an application in multiple different regions, it is desirable to replicate artifacts across the different regions so that the artifacts are available across the multiple different regions when needed. Major cloud providers provide a container registry service at each geographical region that automatically replicates artifacts that are deployed to one of the geographical regions to all other geographical regions where the tenant has requested availability. Because the container registry service is multitenant and often deal with large amounts of data configured into data blobs, it is required that all data be replicated to a new geographical region before any of the artifacts within the replication can be accessed. This can result in an undesirable delay between deployment of an artifact in one region and availability of that artifact in another.

A similar undesirable latency is experienced by tenants when adding a new geographical region for their application. In this instance, none of the data needed by the containerized application is available in the new geographical region at the time the new geographical region is selected for the application. When the user requests geo-replication of their artifacts to the new geographical region, there is a time lag before those images are available in the new geographical region due to the nature of data replication, the number of bytes of data being replicated, and the geographical distances involved in the replication.

The technology described herein solves at least these technical problems by creating a logical overlay network that connects all the container registry services in all regions, allowing them to proxy requests for artifact data to another container registry in another region that has the requested artifact data. Aspects of the disclosure are applicable to any global network of connected machines.

Further, the technology described herein provides fast discovery of and access to data, constrained by the physical distance separating the regions. This improves performance of containerized applications, reduces downtime, and reduces disruptions to container deployment. At least in this manner, aspects of the disclosure improve management, and reduce consumption of compute resources. Further, these features improve the functioning of the underlying computing device.

The technology described herein also improves reliability and resiliency of the compute resources by providing a container registry with private connectivity using a single uniform resource identifier (URI) for all regions. A cloud provider provides a global domain name service (gDNS) to redirect connection requests to endpoints across regions based on real-time conditions including availability, latency, load, etc. In an illustrative implementation, a user can configure private connectivity (e.g., a Private Link) to securely link their virtual network to the container registry using a single global URI that resolves to a local container registry, thereby simplifying deployment across regions as well as leveraging the facility of the gDNS to improve resilience and availability.

The technology described herein also improves privacy and security by only replicating artifact data when it complies with data export rules. This ensures that data sovereignty restrictions on artifact data, based on privacy and security rules, are respected.

The present solution supports streaming of artifact data from a remote location via a local proxy provided by the local container registry in a process entirely transparent to the client. Streaming of artifact data allows container images and other associated artifacts (such as Helm charts or OCI-compliant artifacts) to be consumed with very low latency by authorized and authenticated clients. Streaming of artifact data refers to on-demand fetching of data, generally in smaller chunks rather than the entire artifact or an entire container image. This provides reduced latency to access data from within the artifact that is immediately needed and optimizes network usage because only the data that is required is actually transmitted through the network. With streaming, public cloud resources such as container orchestration platform nodes perform lazy pulling, meaning they start to pull parts of the container images or artifacts as needed at execution time, which eliminates the cost of pulling the entire artifact before it can be consumed.

Furthermore, the present proxying approach in some examples is a supplement to or an alternative to bulk replication. Bulk replication is network bandwidth intensive, often across long geographical instances, and has a high latency cost since the bulk communication of the large data blob requires completion of the entire transmission before any of the artifact data encoded therein is accessible. If bulk artifact data replication is still performed, then the present proxying approach results in immediate availability even if the bulk replication is incomplete. However, with on-demand proxying across regions as described herein, bulk artifact data replication is not needed with the benefit that only data that is truly needed at the target region is copied, and once it is copied it remains available in that region in case it is needed again by the same or a different client. Therefore, while there may be a small additional latency on first request of a specific artifact in the proxying approach as compared to a completed bulk replication (e.g., where the artifact is already present), that latency cost is only for the first request of the data; subsequent requests pull the data from the local datastore with very low latency.

The term “region” as used herein describes a partition of physical or virtualized cloud resources that has a corresponding container registry service for providing artifact data to containerized applications within the region. Physical cloud resources include compute resources (e.g., physical server computers), physical networking, and physical storage systems. Virtualized cloud resources include virtual machines, logical and software-defined networking, and virtualized storage. The partition can be based on geographical region, availability zone, datacenter, failure domain, private or sovereign clouds, or other logical or physical partition of logical or physical cloud resources.

The term “artifact” as used herein refers to a packaged set of data for use by an orchestration platform for deploying and managing containerized applications. In an illustrative implementation, it refers to an artifact formatted according to the OCI specification (an “OCI artifact”), such as an OCI image, for container orchestration platform clusters. In some examples, the container orchestration platform is Kubernetes. However, it should be noted that other data formats and orchestration platforms are contemplated. The term, “artifact data” refers to an artifact, a collection of artifacts, or a portion of an artifact.

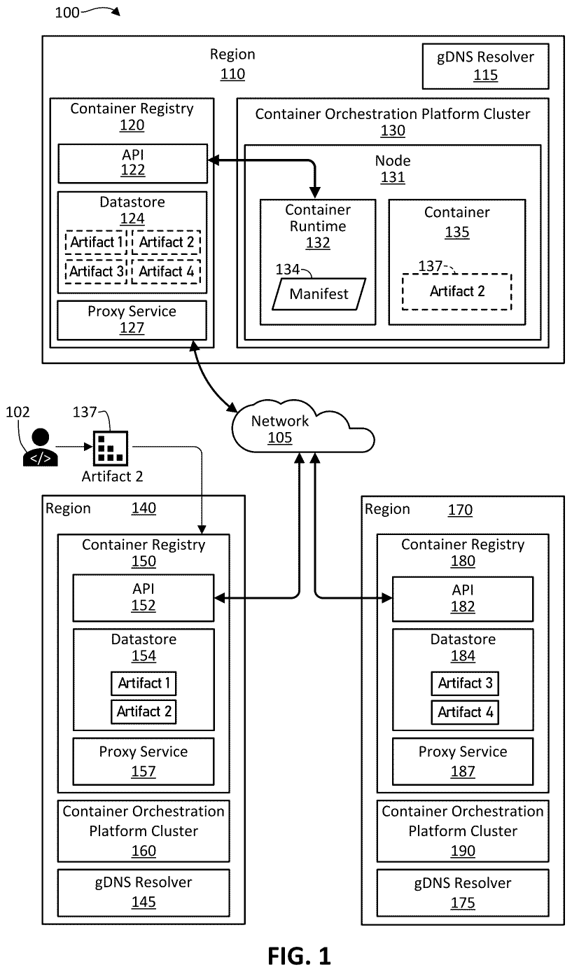

FIG. 1 is a block drawing that illustrates by way of example an environment 100 comprising a plurality of regions 110, 140, 170, and a network 105 connecting the regions 110, 140, 170 with each other.

Each region 110, 140, 170 has a respective container registry 120, 150, 180, a container orchestration platform cluster 130, 160, 190 and a gDNS resolver 115, 145, and 175. Container orchestration platform cluster 130 of region 110 shows more detail than container orchestration platform clusters 160 and 190, but is illustrative of any container orchestration platform cluster in that it includes a node 131 having a container runtime 132, and a container 135. Additional details of container orchestration platform clusters are elided to focus this description on details relevant to the salient features of the container registry described herein. In the OCI specification, the manifest is a JavaScript Object Notation (JSON) file that describes the content of the OCI artifact. It includes a list of layer descriptors including sizes, digests, and media types, as well as configuration information.

Container runtime 132 is responsible for communicating with API 122 of container registry 120 to fetch artifact data from container registry 120. Manifest 134 is retrieved from container registry 120 in an earlier operation according to a well-known process. A digest value is derived from the contents of manifest 134 and this digest value, prepended with a registry identifier that is uniquely associated with a particular tenant, is used as a key for identifying the artifact corresponding to manifest 134. For example, manifest 134 identifies and describes artifact 2 located in datastore 154 in region 140. In this instance, container runtime 132 generates a request submitted to API 122 requesting artifact 2, and identifying artifact 2 based on a digest value derived from the contents of manifest 134. API 122 detects artifact 2 is not present in its local datastore and therefore requests artifact 2 from proxy service 127, which retrieves artifact 2 from container registry 150 in region 140. Proxy service 127 then provides artifact 2 to container runtime 132. In a typical use case, node 131 uses artifact 2 to deploy container 135 based on data from artifact 2.

In an embodiment, user 102 configures a global private endpoint by associating each of a plurality of private internet protocol (IP) addresses for respective container registries 120, 150, 180 with a global uniform resource identifier, and registering these routes with the cloud service provider which propagates the routes, including policies, to each gDNS 115, 145, and 175. Policies direct API queries based on latency, failover, health, etc., as well as geo-political compliance rules, including data privacy regulations and intellectual property protection and other content restrictions. Container runtime 132 therefore has reliable access to an API even if the local API or the local container registry 120 is, for some reason, unavailable. Furthermore, this access is encrypted and private because the IP addresses to which the single URI resolves to will always be a private IP address solely accessible from within user 102's deployment without having to configure separate private links or private endpoints at each region.

Each container registry 120, 150, 180 includes a respective application programming interface (API) 122, 152, 182, a respective datastore 124, 154, 184, and a respective proxy service 127, 157, 187. In an illustrative implementation, each container registry 120, 150, 180 is implemented as a multitenant service, which comprises a scalable cluster of virtual machines or containerized application instances, across which container registry load is distributed using a load balancer (not shown). In alternative implementations, the container registry is a unitary application or a scalable microservices application deployed on one or more physical servers. Additional features included based on implementation but not shown or described herein include management interfaces, firewall and/or other security mechanisms, etc. In yet another implementation, each container registry is intended for a single tenant, e.g., in a private cloud deployment.

Each container registry 120, 150, 180 may be regarded as a collection of sub-services, including APIs 122, 152, 182, datastores 124, 154, 184, and proxy services 127, 157, 187. Each API service 122, 152, 182 exposes, in an illustrative implementation, a representational state transfer (REST) API for communicating with clients or other services. Datastores 124, 154, 184 comprise any suitable data storage device or devices, and may reside locally (e.g., on the same cluster or network) or remotely to its respective container registry. For example, datastore 124, 154, 184 maintains artifacts locally or by leveraging cloud storage services such as object storage services (e.g., binary large objects (BLOB) storage).

As an example, user 102 uploads artifact 137 (“artif. 2”) to container registry 150 in region 140. Container registry 150 stores artifact 137 (shown as “Artifact 2”) in datastore 154. At a later time, container runtime 132 accesses API 122 in region 110 and requests Artifact 2. Container registry 120 does not have it stored locally so using a distributed hash protocol described below, identifies container registry 150 as having Artifact 2, and sends a request for the Artifact 2. Container registry 120 receives Artifact 2 in response to its request, stores a copy of Artifact 2 in its own datastore 124 and forwards the requested artifact data to container runtime 132 via API 122. The storing and forwarding of the artifact can be performed concurrently. Proxy services 127, 157, 187 therefore provide a novel, alternative resource for artifacts. Specifically, instead of waiting for bulk artifact data replication to complete and then retrieving artifacts from datastore 124 in response to an API request, container registry 120 retrieves the requested artifact from container registry 150.

In an illustrative embodiment, each proxy service 127, 157, 187 are connected via a peer-to-peer overlay network, e.g., using an underlying user datagram protocol (UDP) to implement a distributed hash table (DHT) for distributed storage. Each artifact is identified in the DHT using a unique identifier generated by hashing the contents of the artifact.

In an illustrative implementation, proxy services 127, 157, 187 employ a DHT to locate a particular artifact requested via an API request. At a high level, each container registry is assigned a unique identifier, such as a random 128-bit value. Each digest is identified by a unique key. In an illustrative implementation, the key is defined by a first portion containing a registry ID which identifies the tenant, then an underscore, and then a second portion containing a digest of the artifact. The digest is created using a cryptographic hash function. The hash function, and the number of bits assigned to the digest make it extremely unlikely that any two artifacts having differing content will have the same digest value.

A request for an artifact received by one of APIs 122, 152, 182 includes the key for the requested artifact. The API checks its respective datastore to see if the artifact is stored locally. If not, it submits a request to a respective one of proxy services 127, 157, 187 that includes the key.

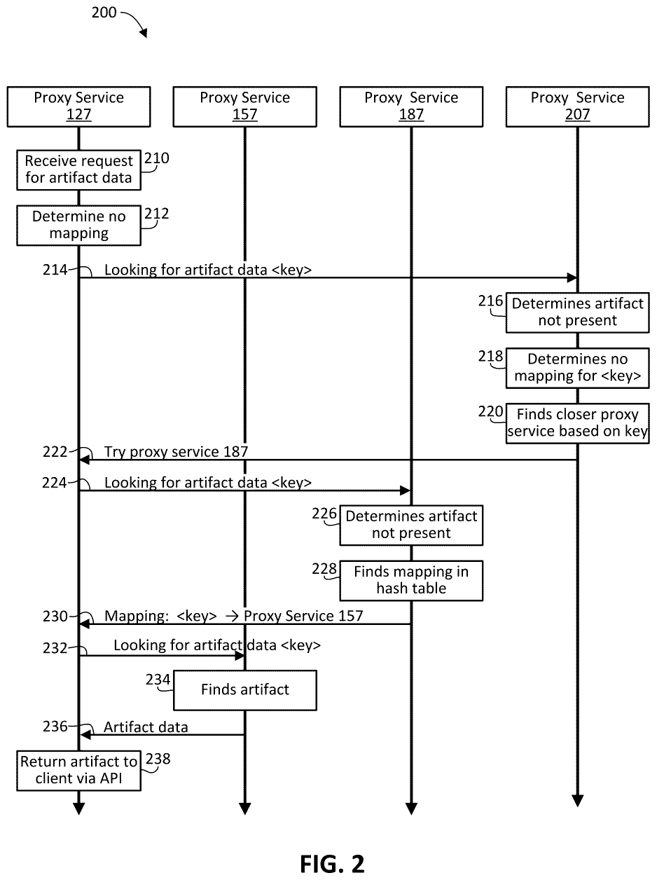

FIG. 2 shows a time-space diagram 200 illustrating by way of example a communication pattern for locating the requested artifact. In this example, proxy service 127 receives a request from its respective API 122 for requested artifact data, which may be an artifact or a portion of an artifact, after determining that the artifact is not locally available. The request includes a key, which optionally includes byte ranges, that uniquely identifies the requested artifact data. Proxy service 127 receives the request in operation 210 and, using its internal hash table, determines in operation 212 that it does not already have a mapping that identifies a container registry that has the requested artifact data. As a result, proxy service 127 contacts via message 214 another proxy service 207 of another container registry in a different region based on the closeness of the registry ID to the key value. The closeness is determined based on XOR distance, which is calculated by performing bitwise XOR operation between the registry's identifier and the key value, where smaller XOR results are considered closer. Message 214 comprises a request for the requested artifact data. In an illustrative embodiment, based on a configured parameter, proxy service 127 may concurrently query a configured number of the closest registries.

Proxy service 207 determines in operation 216 that the requested artifact is not locally available and determines in operation 218 from its internal hash table that it does not have a mapping identifying a region having a copy of the requested artifact data. Proxy service 207 proceeds to operation 220 and consults an internal routing table to identify proxy service 187 which has an identifier that is closer in value to the key, and therefore is more likely to have a mapping. Proxy service 207 then sends message 222 indicating a proxy service 187 as a likelier proxy service to have a mapping for the key in its internal hash table.

Proxy service 127 then sends message 224 to proxy service 187 seeking the requested artifact data. In response, proxy service 187 initially checks to see if it has the requested artifact data. Determining it does not in operation 226, it proceeds to operation 228 and identifies a mapping for the key in its internal hash table. As a result, it generates a message 230 to proxy service 127 identifying proxy service 157 as having a copy of the requested artifact data.

Proxy service 127 then sends a message 232 to proxy service 157 comprising a request for the artifact data. In operation 234, proxy service 157 identifies a local copy of the requested artifact data and sends a message 236 to proxy service 127 including the requested artifact data. In operation 238, proxy service 127 then provides the requested artifact data to the client via API 122 and stores a copy of the requested artifact data in the local datastore.

If the other container registry does not have a mapping of a registry ID for the key value, then it responds with contact information for another container registry that has a registry ID closer to the key value. After one or more iterations, a container registry will have a mapping for the registry ID (if it exists) that identifies a target container proxy, the mapping will be returned to the proxy service. Once the proxy service has the mapping, it sends request for the artifact to the target container proxy. Upon receipt of the artifact data, it is forwarded to the client by the API service.

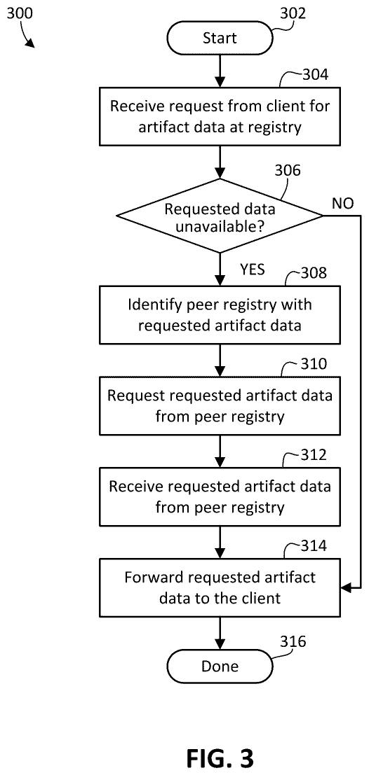

FIG. 3 shows a flowchart 300 illustrating by way of example a process for proxying a request for artifact data. The process begins as indicated by start block 302 and proceeds to operation 304 in which a request for artifact data is received at a first container registry from a client of the first container registry. In response to the request, the first container registry checks in operation 306 its local datastore to determine if the artifact data is locally available. If the artifact data is available, then the procedure flows to operation 314, which is described below. If the data is unavailable, however, then the procedure flows to operation 308.

In operation 308, the container registry identifies a peer registry that has the requested artifact data. As described above with reference to FIG. 2, the container registry uses a distributed hash table and an overlay peer-to-peer network to identify the peer registry having the requested artifact data.

After identifying the peer registry with the requested artifact data, the first container registry requests the artifact data from the peer registry in operation 310. In operation 312, the requested artifact data is received at the first container registry from the peer container registry. Upon receipt of the requested artifact data by the first container registry, or upon determining in operation 306 that the requested artifact data is locally available, the requested artifact data is forwarded to the client via the API in operation 314. In addition, the requested artifact data is stored in the local datastore. The procedure then ends as indicated by block 316.

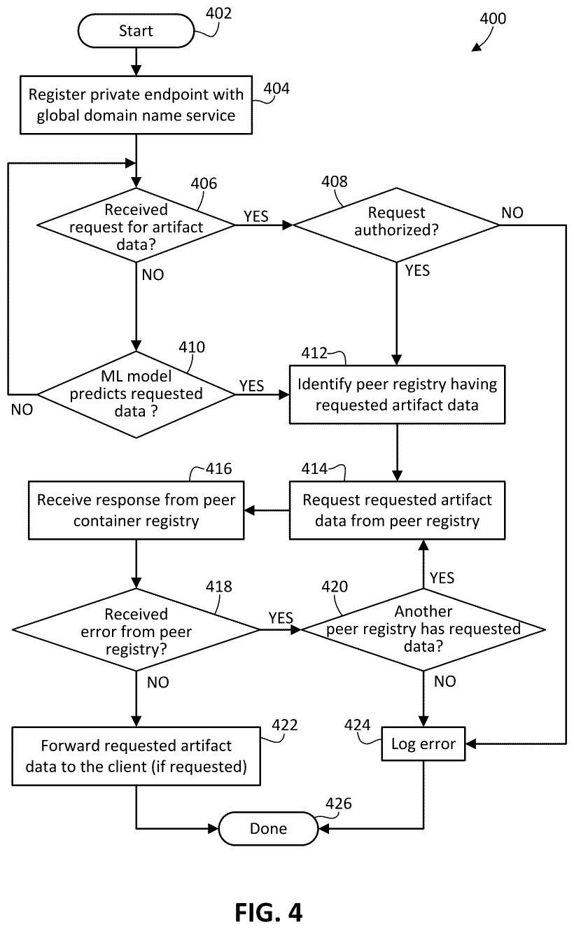

FIG. 4 shows a flowchart 400 illustrating by way of example a procedure for proxying requests for artifact data. The procedure begins as indicated by start block 402 and proceeds to operation 404 in which a user registers a private IP address linked to the container proxy with a single URI. The single URI allows container runtime 132 to access container registry 120 by querying gDNS resolver 115 for an IP address associated with the URI. Having been registered in operation 404, container runtime 132 receives the IP address from gDNS resolver 115, and then accesses container registry 120 via the IP address. Major cloud providers provide gDNS resolvers that provide the appropriate IP address that is local to the querier—in this case, container runtime 132—by performing latency-based routing. A failover policy may be provided that provides the IP address of a second container registry in a second region, e.g., container registry 150 in region 140, if the local container registry is unavailable. In addition, the IP address is a private IP address that is only accessible from within the user's virtual network and has no exposure to the public internet.

In operation 406, container registry 120 determines whether a request for artifact data is received from a client. For example, API 122 received a request from container runtime 132 for an artifact such as a container image or a portion thereof. If a request is received, it is authenticated and authorized in operation 408 to ensure that (1) the request is received from an authorized client and (2) that it has not been modified. In an illustrative implementation, this is done using standard authentication certificates and encryption technologies. If the request is unauthorized, unverified, or otherwise invalid, then the procedure flows to operation 424 wherein the error is logged, and the procedure ends as indicated by block 426. Otherwise, the procedure flows to operation 412, discussed below.

Returning to operation 406, if a request has not been received, then the procedure flows to operation 410 wherein it is determined whether artifact data should be replicated from a remote region proactively in anticipation of a request for artifact data that is not already locally available. In an example implementation, container registry 120 logs various operations in one or more log files and a machine learning (ML) model is trained on the log data in these files to identify patterns of artifact data retrieval using ML pattern recognition techniques. By analyzing historical log entries, the ML model (not shown) learns to identify anomalies, recurrent behaviors, or signatures that precede certain events such as a request for artifact data. Once a prediction is made, the ML model triggers a pre-emptive action to pull the artifact data ahead of receiving the request. In this case, the ML model ingests raw log data generated by container registry 120, and parses the log data to extract structured information from each entry, such as timestamps, event codes, and metrics, etc.

For example, an implementation provides for features, including detection of the receipt of and requests for manifest data, that are derived from the structured data. Techniques including natural language processing (NLP) are applied to extract relevant information from the textual content of logs. Features like timestamps, event frequencies, and metrics are normalized to a common scale to improve the model's performance. The model is built using a time-series prediction architecture, such as Long Short-Term Memory (LSTM) networks or Temporal Convolutional Networks (TCN) for learning dependencies over time. Using historical log data that is labeled with known events, a supervised learning model such as Gradient Boosting Machines (GBM) or Random Forest is used to classify patterns that are predictive of these events. In a more advanced implementation, reinforcement learning agents are deployed to learn optimal actions based on system states predicted by the model. The agent receives rewards for minimizing negative outcomes (e.g., receiving a request for an artifact that is not locally available).

After training, the model continuously monitors incoming log data in real-time. By analyzing patterns in near real-time, the model predicts the likelihood of a specific event occurring, e.g., the request for a particular artifact. Based on the predicted event, the model preemptively requests the artifact data associated with the predicted request in operation 410.

For example, the ML model detects a pattern that whenever a new version of a particular manifest is replicated to the local region, a client requests an instance of the corresponding updated artifact within an hour, before the artifact is replicated using the cloud service provider's bulk replication service. Having identified this pattern, the ML model responds to a detection in a log file that a new version of a manifest is received, to immediately pull the corresponding updated artifact from a remote region by generating a request in operation 410. In this case, the procedure flows to operation 412; if not, the procedure returns to operation 406 described above.

In operation 412, container registry 120 identifies a peer registry having the requested artifact data. In an illustrative implementation, a distributed hash table as described above with reference to FIG. 2 is employed to identify a peer container registry that has the requested artifact data. The procedure then flows to operation 414 wherein container registry 120 sends a message to the peer container registry for the requested artifact data and in operation 416 a response is received therefrom.

In operation 418 it is determined whether the response included an error message indicating that the requested artifact data cannot be retrieved from the peer container registry, e.g., due to data export restrictions. In this case, the procedure flows to operation 420 to check if another peer container registry has the requested artifact data and if so, a new request is made to the other peer container registry in operation 414. If no other peer container registry can be found with the requested artifact data, then an error is logged in operation 424 and the procedure ends as indicated by block 426.

Returning to operation 418, if no error is present, then if the data was requested by a client and not preemptively by the ML model, the requested artifact data is forwarded to the client that requested it via API 122 in operation 422. Whether requested by a client or preemptively requested, the artifact data is locally stored in the container registry's datastore. The procedure then ends as indicated by block 426.

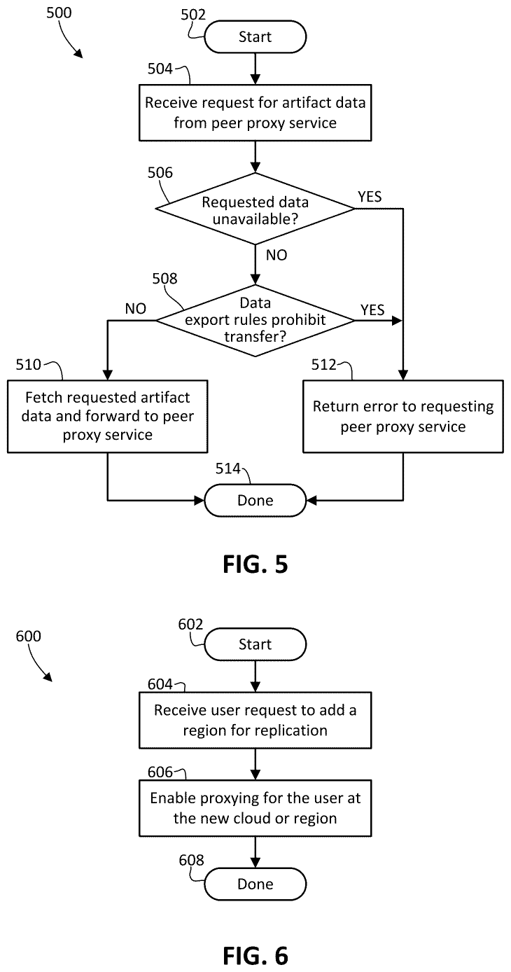

FIG. 5 shows a flowchart 500 illustrating by way of example a procedure for a container registry to follow when receiving a request for artifact data from peer container registry acting as a proxy. The procedure begins as indicated by start block 502 and proceeds to operation 504 wherein a request for artifact data is received from a peer container registry. In response thereto, the procedure flows to operation 506, wherein the container registry checks its datastore to determine if the requested artifact data is locally unavailable. If the requested artifact data is unavailable locally, the procedure flows to operation 512 to return an error to the peer container registry.

In an alternative solution (not shown in FIG. 5), the container registry follows the procedure described above with reference to FIG. 2 in which it first checks its internal hash table to see if it has a mapping that maps the requested artifact data to a second container registry. If so, the container registry returns the mapping information to the requesting peer container registry and if not, it checks its internal routing table to see if it can identify a second peer container registry that has an identifier value closer to the digest value for the requested artifact data. In some peer-to-peer DHT protocols, the closer the identifier value is to the digest value, the more likely the registry will have mapping information. If a second peer container registry exists that has an identifier value closer to the digest value, then that information pertaining to the second peer container service is provided to the peer container service or else an error message is returned to the peer container service.

Returning to operation 506, if the requested data is available, then the procedure flows to operation 508 in which data export rules are checked against the requested artifact data to determine if the requested artifact data is permitted to be sent to the peer container registry. For example, the requesting peer container registry resides in a geographic region which is prohibited from having data sent to it due to its non-compliance with data privacy regulations that apply to data residing in the local geographic region. If data export rules prohibit transmission of the requested artifact data in operation 508, then the procedure flows to operation 512 wherein an error is returned to the requesting peer container registry. If the data export rules do not prohibit the replication of the requested artifact data to the target region, then the procedure flows to operation 510 in which the requested artifact data is fetched and forwarded to the requesting peer container registry. The procedure then ends as indicated by block 514.

FIG. 6 shows flowchart 600 illustrating by way of example a procedure for enabling proxying to a new region. This procedure can be implemented by a cloud provider using its management portal and management infrastructure. The procedure begins as indicated by start block 602 and flows to operation 604 wherein a user request is received for adding a new region for artifact replication. In response thereto, the procedure flows to operation 606 wherein the cloud provider enables proxying by the local container registry in that region for the user. The procedure then completes as indicated by block 608. Once proxying is enabled, the user is able to immediately access artifact data even though it may take many hours for the user's artifact data to be replicated to the new region via the cloud provider's bulk data replication service. As previously described, the proxying is governed by export rules. Additionally, in an illustrative implementation, bulk data replication may be disabled in favor of the proxying solution described above. The bulk replication may be disabled at a cloud level, at a tenant level (e.g., using a tenant-accessible configuration), or at the level of individual clusters.

### Additional Examples

An example system for proxying requests for artifact data from a first region of a public cloud service to a second region of the public cloud service comprises a processor for executing instructions and a computer storage medium for storing the instructions. The instructions case the processor to: identify the request for the artifact data at a first container registry at the first region; determine that the artifact data is locally unavailable; and, in response to the determining that the artifact data is locally unavailable, identify a peer container registry at the second region that has a copy of the artifact data and send a request to the peer container registry for the copy of the artifact data. The instructions further cause the processor to receive the artifact data from the peer container registry and store the artifact data to a local datastore.

Alternatively, or in addition to the other examples described herein, examples include any combination of the following:
wherein the first container registry and the peer container registry each have a proxy service that implements a distributed hash table for storing mappings between a key that uniquely identifies the artifact data and a region having a copy of the artifact data.
wherein the first region is a first geographic region and the second region is a second geographic region that is distinct from the first geographic region.
wherein the request is received from a client in the first region via an application programming interface (API) provided by the first container registry, and, in response to the receiving of the artifact data, forwarding the artifact data to the client via the API.
wherein the instructions further cause the processor to generate the request based on a prediction from a machine learning (ML) model, the ML model generating the request based on pattern recognition of log data, and a prediction based on patterns of events in the log data that a client request for the artifact data will be received from a client in the first region.
wherein the instructions further cause the processor to receive an error from the peer container registry indicating it is not able to send the copy of the artifact data and, in response to receiving the error from the peer container registry, identify a second peer container registry having a second copy of the artifact data and send a request to the second peer container registry for the artifact data.
wherein the artifact data is a package of data conformant to Open Container Initiative (OCI) standards for container artifacts and the container registry supports OCI application programing interface (API) specifications.

An example method for proxying requests for artifact data from a first region of a public cloud service to a second region of the public cloud service comprises: receiving the request for the artifact data at a first container registry at the first region from a client at the first region; determining that the artifact data is locally unavailable; and in response to the determining that the artifact data is locally unavailable, identifying a peer container registry at the second region that has a copy of the artifact data and send a request to the peer container registry for the copy of the artifact data. The method further comprises receiving the artifact data from the peer container registry and forwarding the artifact data to the client.

Alternatively, or in addition to the other examples described herein, examples include any combination of the following:
wherein the first container registry and the peer container registry each have a proxy service that implements a distributed hash table for storing a mapping between a key that uniquely identifies the artifact data and a region having a copy of the artifact data.
wherein the distributed hash table is also implemented by a second peer container registry and the identifying of the peer container registry comprises: determining, from an internal hash table, that the container registry does not have the mapping; determining, based on a value of the key and an identifier of the second peer container registry that the second peer container registry is likely to have the mapping; sending a message to the second peer container registry including the key; and receiving the mapping in a response to the message, the response being from the second peer container registry, the mapping identifying the peer container registry.
wherein the first region is a first geographic region and the second region is a second geographic region that is distinct from the first geographic region.
wherein the request is received from the client in the first region via an application programming interface (API) provided by the first container registry, and, in response to the receiving of the artifact data, the artifact data is forwarded to the client via the API.
wherein the method further comprises receiving an error from the peer container registry indicating it is not able to send the copy of the artifact data and, in response to the receiving of the error from the peer container registry, identifying a second peer container registry having a second copy of the artifact data and sending a request to the second peer container registry for the artifact data.
wherein the artifact data is a package of data conformant to Open Container Initiative (OCI) standards for container artifacts and the container registry supports OCI application programing interface (API) specifications.

An example non-transitory computer storage medium encoding instructions for execution on a processor cause the processor to: identify a request for artifact data at a first container registry in a first region; determine that the artifact data is locally unavailable; and in response to the determining that the artifact data is locally unavailable, identify a peer container registry in a second region that has a copy of the artifact data and send a request to the peer container registry for the copy of the artifact data. The instructions further cause the processor to receive the artifact data from the peer container registry and store the artifact data to a local datastore.

Alternatively, or in addition to the other examples described herein, examples include any combination of the following:
wherein the first container registry and the peer container registry each have a proxy service that implements a distributed hash table for storing mappings between a key that uniquely identifies the artifact data and a region having a copy of the artifact data.
wherein the first region is a first geographic region and the second region is a second geographic region that is distinct from the first geographic region.
wherein the request is received from a client in the first region via an application programming interface (API) provided by the first container registry, and, in response to the receiving of the artifact data, forwarding the artifact data to the client via the API.
wherein the instructions further cause the processor to generate the request based on a prediction from a machine learning (ML) model, the ML model generating the request based on pattern recognition of log data, and a prediction based on patterns of events in the log data that a client request for the artifact data will be received from a client in the first region.
wherein the artifact data is a package of data conformant to Open Container Initiative (OCI) standards for container artifacts and the container registry supports OCI application programing interface (API) specifications.

### Example Operating Environment

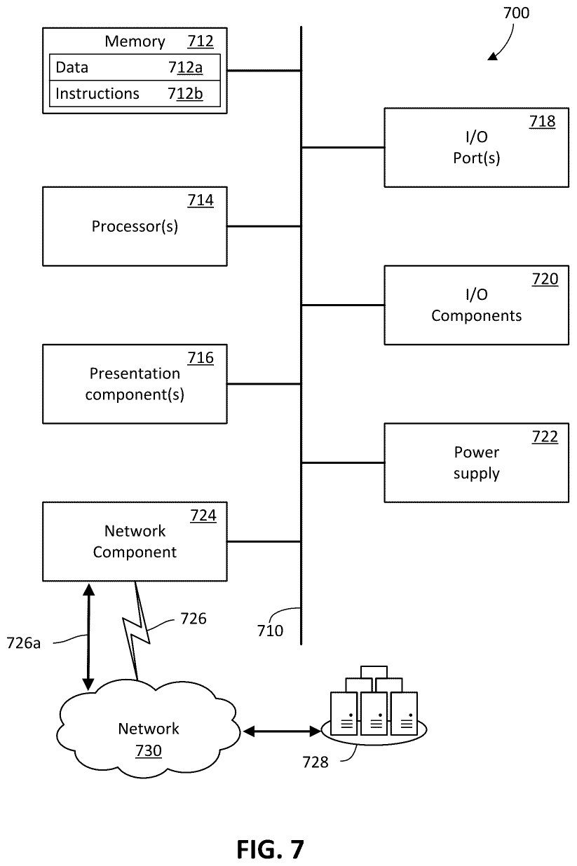

FIG. 7 is a block diagram of an example computing device 700 (e.g., a computer storage device) for implementing aspects disclosed herein, and is designated generally as computing device 700. In some examples, one or more computing devices 700 are provided for an on-premises computing solution. In some examples, one or more computing devices 700 are provided as a cloud computing solution. In some examples, a combination of on-premises and cloud computing solutions are used. Computing device 700 is but one example of a suitable computing environment and is not intended to suggest any limitation as to the scope of use or functionality of the examples disclosed herein, whether used singly or as part of a larger set.

Neither should computing device 700 be interpreted as having any dependency or requirement relating to any one or combination of components/modules illustrated. The examples disclosed herein can be described in the general context of computer code or machine-useable instructions, including computer-executable instructions such as program components, being executed by a computer or other machine, such as a personal data assistant or other handheld device. Generally, program components including routines, programs, objects, components, data structures, and the like, refer to code that performs particular tasks, or implement particular abstract data types. The disclosed examples can be practiced in a variety of system configurations, including personal computers, laptops, smart phones, mobile tablets, hand-held devices, consumer electronics, specialty computing devices, etc. The disclosed examples can also be practiced in distributed computing environments when tasks are performed by remote-processing devices that are linked through a communications network.

Computing device 700 includes a bus 710 that directly or indirectly couples the following devices: computer storage memory 712, one or more processors 714, one or more presentation components 716, input/output (I/O) ports 718, I/O components 720, a power supply 722, and a network component 724. While computing device 700 is depicted as a seemingly single device, multiple computing devices 700 can work together and share the depicted device resources. For example, memory 712 is distributed across multiple devices, and processor(s) 714 is housed with different devices.

Bus 710 represents one or more busses (such as an address bus, data bus, or a combination thereof). Although the various blocks of FIG. 17 are shown with lines for the sake of clarity, delineating various components can be accomplished with alternative representations. For example, a presentation component such as a display device is an I/O component in some examples, and some examples of processors have their own memory. Distinction is not made between such categories as “workstation,” “server,” “laptop,” “hand-held device,” etc., as all are contemplated within the scope of FIG. 17 and the references herein to a “computing device.” Memory 712 can take the form of the computer storage media referenced below and operatively provide storage of computer-readable instructions, data structures, program modules and other data for the computing device 700. In some examples, memory 712 stores one or more of an operating system, a universal application platform, or other program modules and program data. Memory 712 is thus able to store and access data 712a and instructions 712b that are executable by processor 714 and configured to carry out the various operations disclosed herein.

In some examples, memory 712 includes computer storage media. Memory 712 can include any quantity of memory associated with or accessible by the computing device 700. Memory 712 can be internal to the computing device 700 (as shown in FIG. 17), external to the computing device 700 (not shown), or both (not shown). Additionally, or alternatively, the memory 712 can be distributed across multiple computing devices 700, for example, in a virtualized environment in which instruction processing is carried out on multiple computing devices 700. For the purposes of this disclosure, “computer storage medium,” “computer-storage memory,” “memory,” and “memory devices” are synonymous terms for the computer-storage memory 712, and none of these terms include carrier waves or propagating signaling.

Processor(s) 714 includes any quantity of processing units that read data from various entities, such as memory 712 or I/O components 720. Specifically, processor(s) 714 are programmed to execute computer-executable instructions for implementing aspects of the disclosure. The instructions can be performed by the processor, by multiple processors within the computing device 700, or by a processor external to the client computing device 700. In some examples, the processor(s) 714 are programmed to execute instructions such as those illustrated in the flow charts discussed below and depicted in the accompanying drawings. Moreover, in some examples, the processor(s) 714 represent an implementation of analog techniques to perform the operations described herein. For example, the operations are performed by an analog client computing device 700 and/or a digital client computing device 700. Presentation component(s) 716 present data indications to a user or other device. Exemplary presentation components include a display device, speaker, printing component, vibrating component, etc. It should be understood that computer data can be presented in a number of ways, such as visually in a graphical user interface (GUI), audibly through speakers, wirelessly between computing devices 700, across a wired connection, or in other ways. I/O ports 718 allow computing device 700 to be logically coupled to other devices including I/O components 720, some of which can be built in. Example I/O components 720 include, for example but without limitation, a microphone, joystick, game pad, satellite dish, scanner, printer, wireless device, etc.

Computing device 700 can operate in a networked environment via the network component 724 using logical connections to one or more remote computers. In some examples, the network component 724 includes a network interface card and/or computer-executable instructions (e.g., a driver) for operating the network interface card. Communication between the computing device 700 and other devices can use any protocol or mechanism over any wired or wireless connection. In some examples, network component 724 is operable to communicate data over public, private, or hybrid (public and private) using a transfer protocol, between devices wirelessly using short range communication technologies (e.g., near-field communication (NFC), Bluetooth branded communications, or the like), or a combination thereof. Network component 724 communicates over wireless communication link 726 and/or a wired communication link 726a to a remote resource 728 (e.g., a cloud resource) across network 730. Various different examples of communication links 726 and 726a include a wireless connection, a wired connection, and/or a dedicated link, and in some examples, at least a portion is routed through the internet.

Although described in connection with an example computing device 700, examples of the disclosure are capable of implementation with numerous other general-purpose or special-purpose computing system environments, configurations, or devices. Examples of well-known computing systems, environments, and/or configurations that suitable for use with aspects of the disclosure include, but are not limited to, smart phones, mobile tablets, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, virtual reality (VR) devices, augmented reality (AR) devices, mixed reality devices, holographic device, and the like. Such systems or devices might accept input from the user in any way, including from input devices such as a keyboard or pointing device, via gesture input, proximity input (such as by hovering), and/or via voice input.

Examples are described in the general context of computer-executable instructions, such as program modules, executed by one or more computers or other devices in software, firmware, hardware, or a combination thereof. The computer-executable instructions can be organized into one or more computer-executable components or modules. Generally, program modules include, but are not limited to, routines, programs, objects, components, and data structures that perform particular tasks or implement particular abstract data types. Aspects of the disclosure can be implemented with any number and organization of such components or modules. For example, aspects of the disclosure are not limited to the specific computer-executable instructions or the specific components or modules illustrated in the figures and described herein. Other examples of the disclosure include different computer-executable instructions or components having more or less functionality than illustrated and described herein. In examples involving a general-purpose computer, aspects of the disclosure transform the general-purpose computer into a special-purpose computing device when configured to execute the instructions described herein.

By way of example and not limitation, computer readable media comprise computer storage media and communication media. Computer storage media include volatile and nonvolatile, removable and non-removable memory implemented in any method or technology for storage of information such as computer readable instructions, data structures, program modules, or the like. Computer storage media are tangible and mutually exclusive to communication media. Computer storage media are implemented in hardware and exclude carrier waves and propagated signals. Computer storage media for purposes of this disclosure are not signals per se. Exemplary computer storage media include hard disks, flash drives, solid-state memory, phase change random-access memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium for storing information for access by a computing device. In contrast, communication media typically embody computer readable instructions, data structures, program modules, or the like in a modulated data signal such as a carrier wave or other transport mechanism and include any information delivery media.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

In examples involving a general-purpose computer, aspects of the disclosure transform the general-purpose computer into a special-purpose computing device when configured to execute the instructions described herein.

It will be understood that the benefits and advantages described above can relate to one embodiment or to several embodiments. The embodiments are not limited to those that solve any or all the stated problems or those that have any or all of the stated benefits and advantages. It will further be understood that reference to ‘an’ item refers to one or more of those items.

The term “comprising” is used in this specification to mean including the feature(s) or act(s) followed thereafter, without excluding the presence of one or more additional features or acts.

In some examples, the operations illustrated in the figures are implemented as software instructions encoded on a computer storage medium, in hardware programmed or designed to perform the operations, or both. For example, aspects of the disclosure are implemented as a system on a chip or other circuitry including a plurality of interconnected, electrically conductive elements.

The order of execution or performance of the operations in examples of the disclosure illustrated and described herein is not essential, unless otherwise specified. That is, the operations can be performed in any order, unless otherwise specified, and examples of the disclosure can include additional or fewer operations than those disclosed herein. For example, it is contemplated that executing or performing a particular operation before, contemporaneously with, or after another operation is within the scope of aspects of the disclosure.

As used herein, the term “set” is non-empty, and can also be referred to as a “group.”

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there might be additional elements other than the listed elements. The term “exemplary” is intended to mean “an example of.” The phrase “one or more of the following: A, B, and C” means “at least one of A and/or at least one of B and/or at least one of C.”

While the aspects of the disclosure have been described in terms of various examples with their associated operations, a person skilled in the art would appreciate that a combination of operations from any number of different examples is also within scope of the aspects of the disclosure.

What is claimed is:

1. A system for proxying requests for artifact data from a first region of a cloud service to a second region of the cloud service, the system comprising:
a processor for executing instructions; and
a computer storage medium for storing the instructions, the instructions causing the processor to:
identify a request for artifact data at a first container registry in the first region;
determine that the artifact data is locally unavailable;
based on the determination that the artifact data is locally unavailable, identify a peer container registry in the second region that has a copy of the artifact data and send a request to the peer container registry for the copy of the artifact data;
receive the artifact data from the peer container registry; and
store the artifact data to a local datastore.

2. The system of claim 1, wherein the first container registry and the peer container registry each have a proxy service that implements a distributed hash table for storing mappings between a key that uniquely identifies the artifact data and a region having a copy of the artifact data.

3. The system of claim 1, wherein the first region is a first geographic region and the second region is a second geographic region that is distinct from the first geographic region.

4. The system of claim 1, wherein the request is received from a client in the first region via an application programming interface (API) provided by the first container registry, and, in response to the receiving of the artifact data, forwarding the artifact data to the client via the API.

5. The system of claim 1 wherein the instructions further cause the processor to:
generate the request based on a prediction from a machine learning (ML) model, the ML model generating the request based on pattern recognition of log data, and a prediction based on patterns of events in the log data that a client request for the artifact data will be received from a client in the first region.

6. The system of claim 1 wherein the instructions further cause the processor to:
identify an initial peer container registry in in a third region as a potential source for the copy of the artifact data;
send an initial request to the initial peer container registry for the copy of the artifact data;
receive a response from the initial peer container registry indicating it is not able to send the copy of the artifact data, the response from the initial peer container registry further identifying the peer container registry as having the artifact data, the identification of the peer container registry in the second region as having the copy of the artifact data being based on the response from the initial peer container registry.

7. The system of claim 1 wherein the artifact data is a package of data conformant to Open Container Initiative (OCI) standards for container artifacts and the first container registry supports OCI application programing interface (API) specifications.

8. A computerized method comprising:
receiving a request for artifact data at a first container registry in a first region of a cloud service from a client at the first region;
determining that the artifact data is locally unavailable; and
identifying a peer container registry in a second region that has a copy of the artifact data and sending a request to the peer container registry for the copy of the artifact data;
receiving the artifact data from the peer container registry; and
forwarding the artifact data to the client.

9. The method of claim 8, wherein the first container registry and the peer container registry each have a proxy service that implements a distributed hash table for storing a mapping between a key that uniquely identifies the artifact data and a region having the copy of the artifact data.

10. The method of claim 9, wherein the distributed hash table is also implemented by a second peer container registry and the identifying of the peer container registry comprises:
determining, from an internal hash table, that the container registry does not have the mapping;
determining, based on a value of the key and an identifier of the second peer container registry that the second peer container registry is likely to have the mapping;
sending a message including the key to the second peer container registry; and
receiving the mapping in a response to the message, the response being from the second peer container registry, the mapping identifying the peer container registry.

11. The method of claim 8, wherein the first region is a first geographic region and the second region is a second geographic region that is distinct from the first geographic region.

12. The method of claim 8, wherein the request is received from the client in the first region via an application programming interface (API) provided by the first container registry, and, in response to the receiving of the artifact data, the artifact data is forwarded to the client via the API.

13. The method of claim 8, further comprising:
identifying an initial peer container registry in a third region as a potential source for the copy of the artifact data;
sending an initial request to the initial peer container registry for the copy of the artifact data;
receiving a response from the initial peer container registry indicating it is not able to send the copy of the artifact data, the response from the initial peer container registry further identifying the peer container registry as having the artifact data, the identification of the peer container registry in the second region as having the copy of the artifact data being based on the response from the initial peer container registry.

14. The method of claim 8 wherein the artifact data is a package of data conformant to Open Container Initiative (OCI) standards for container artifacts and the first container registry supports OCI application programing interface (API) specifications.

15. A computer storage medium encoding instructions for execution on a processor, the instructions causing the processor to:
identify a request for artifact data at a first container registry in a first region, and in response thereto:
determine that the artifact data is locally unavailable;
identify a peer container registry in a second region that has a copy of the artifact data;
send a request to the peer container registry for the copy of the artifact data;
receive the artifact data from the peer container registry; and
store the artifact data to a local datastore.

16. The computer storage medium of claim 15, wherein the first container registry and the peer container registry each have a proxy service that implements a distributed hash table for storing mappings between a key that uniquely identifies the artifact data and a region having the copy of the artifact data.

17. The computer storage medium of claim 15, wherein the first region is a first geographic region and the second region is a second geographic region that is distinct from the first geographic region.

18. The computer storage medium of claim 15, wherein the request is received from a client in the first region via an application programming interface (API) provided by the first container registry, and, in response to the receiving of the artifact data, forwarding the artifact data to the client via the API.

19. The computer storage medium of claim 15, wherein the instructions further cause the processor to:
generate the request based on a prediction from a machine learning (ML) model, the ML model generating the request based on pattern recognition of log data, and a prediction based on patterns of events in the log data that a client request for the artifact data will be received from a client in the first region.

20. The computer storage medium of claim 15, wherein the artifact data is a package of data conformant to Open Container Initiative (OCI) standards for container artifacts and the first container registry supports OCI application programing interface (API) specifications.
